(19) United States
(12) Patent Application Publication
(10) Pub. No.: US 2016/0090990 A1
(43) Pub. Date: Mar. 31, 2016

(54) ARRANGEMENT HAVING A SEAL

(71) Applicant: SIEMENS AKTIENGESELLSCHAFT, München (DE)

(72) Inventor: Wolfgang Zacharias, Duisburg (DE)

(73) Assignee: Siemens Aktiengesellschaft, Munich (DE)

(21) Appl. No.: 14/889,247

(22) PCT Filed: Apr. 22, 2014
(86) PCT No.: PCT/EP2014/058058

§ 371 Date: Nov. 5, 2015

(30) Foreign Application Priority Data
May 7, 2013 (DE) 10 2013 208 357.2

(51) Int. Cl. F04D 29/08; F16J 15/06

(52) U.S. Cl. CPC F04D 29/08; F16J 15/061

(57) ABSTRACT

An arrangement having a seal, includes: a casing, a cover, and at least one seal. In order to ensure damage-free installation of the cover and simultaneously simplify the installation process itself, as well as to guarantee good sealing, the arrangement has a seal carrier, the seal carrier has a first radial groove extending in the circumferential direction and having a radial depth direction, in which first radial groove a first radial seal is arranged, which seals against a radially inward surface of the casing, the seal carrier has a first axial groove extending in the circumferential direction and having an axial depth direction, in which first axial groove a first axial seal is arranged, which seals against an axial surface of the cover.

### CROSS REFERENCE TO RELATED APPLICATIONS

This application is the US National Stage of International Application No. PCT/EP2014/058058 filed Apr. 22, 2014, and claims the benefit thereof. The International application claims the benefit of German Application No. DE 102013208357.2 filed May 7, 2013. All of the applications are incorporated by reference herein in their entirety.

### FIELD OF INVENTION

The invention relates to an arrangement having a seal, comprising: a casing of a turbomachine, a cover, at least one seal, wherein the casing has a longitudinal axis, wherein the cover is introduced into the casing in the axial direction in order to close an end-face opening of the casing.

### BACKGROUND OF INVENTION

An exemplary field of application for this technology is that of turbomachines, in particular turbocompressors. The technology may in principle also be used on other pressurized containers. Turbomachines, because of their construction, have at many points separating faces at which the conveyed medium must be sealed off from the surroundings. In particular in the case of gases which can form an explosive mixture with ambient air, or which contain toxic fractions, sealing becomes particularly important. Various sealing elements are used for sealing. All conventional sealing elements require a surface which is matched to the sealing element and which must not be damaged in order that the sealing function is maintained. In many cases, the respective sealing face also has a centering function. Damage to the sealing faces can make it necessary to undertake onerous removal and installation of heavy components. In particular in the case of casings having what is termed a barrel-type construction—that is to say casings which have no horizontal parting joint or parting joint which extends in the longitudinal axis of the cylindrical casing—sealing installation of an end-face cover is particularly difficult. The end-face cover is generally very heavy and requires a load-bearing guide when inserting the cover into the barrel casing, if the cover does not simply bear against the end face but is at least partially surrounded in the circumferential direction by the jacket-shaped casing. If the cover is at the same time the carrier for the seals, intended or unintended contact between the seal and the casing can damage the seal, because, in said contact, the cover overloads the seal because of the great weight and relative inaccessibility of the former in the installation situation.

A generic arrangement is already known from FR 2044 199 A5.

Sealing arrangements with various seal carriers are already known from U.S. Pat. No. 6,923,476 B2, JP H11-303 998 A and DE 10 2011 108 273 A1.

A hydraulic piston having a seal carrier within the cylinder is known from U.S. Pat. No. 3,975,991A1.

### SUMMARY OF INVENTION

The invention has an object of using structural measures to ensure damage-free cover installation and at the same time to simplify the installation procedure itself and to ensure good sealing.

To achieve this object according to aspects of the invention, there is proposed an arrangement having at least one seal according to the type mentioned in the introduction, having the additional features of the independent claim. The subclaims which respectively refer back, contain advantageous refinements of the invention.

The seal carrier, according to aspects of the invention, having the radial and axial grooves which extend in the circumferential direction and which seal, with the seals introduced there, respectively against a radial or axial surface of the casing or of the cover, first allows the cover to be installed in the casing without a seal so as to prevent damage to the seal in this installation step. The seal carrier with the seals located therein is substantially lighter, and therefore simpler to install, than the cover. Exactly controlled and, where possible, manual installation of the seal carrier can thus take place simply and without damage. The invention provides that the cover is arranged axially further inside the casing than the seal carrier, such that the seal carrier bears with the seals axially against the cover from the outside. This makes it simple to monitor the sealing function and, if it is necessary to replace the seal, this can take place without removing the cover. Furthermore, the cover for the seal serves as a thermal buffer in the event that the fluid present in the pressurized container or casing is a particularly hot or cold fluid.

Advantageously, the casing is a barrel casing, i.e. a casing without a parting joint parallel to the axis of longitudinal extent of the casing. In the event that the casing is the casing of a turbomachine or a turbocompressor, no parting joint of the casing would extend parallel to an axis of rotation of the turbomachine.

Another advantageous refinement of the invention provides that the seal carrier has a second radial groove extending in the circumferential direction with a radial depth direction, in which there is arranged a second radial seal which seals against a radially inner surface of the casing and/or the seal carrier has a second axial groove extending in the circumferential direction with an axial depth direction, in which there is arranged a second axial seal which seals against an axial surface of the casing.

A further advantageous refinement of the invention provides that between the first radial groove and the second radial groove there is provided on the seal carrier a radial suction groove extending in the circumferential direction, and/or between the first axial groove and the second axial groove there is provided on the seal carrier an axial suction groove extending in the circumferential direction, which suction groove(s) is/are connected to at least one suction line.

Particularly advantageously, it is expedient if the suction line extends from the axial suction groove through the seal carrier to the radial suction groove and continues from the radial suction groove through the casing. It is thus possible to provide just a single suction which opens in the suction line and to simultaneously secure, with this suction, the radial seal and the axial seal in particular against egress of toxic or explosive gases. Expediently, the seal carrier is made from a particularly high-strength material. Particularly, the seal carrier itself is made of metal so as to ensure high dimensional stability and chemical resistance with respect to possible aggressive process fluids.

Expediently, the arrangement according to the invention can comprise fixing elements for fixing the cover to the casing, wherein the fixing elements comprise a fixing ring which extends in the circumferential direction and is segmented in the circumferential direction, and which bears axially against the seal carrier and is directly or indirectly fixed and/or supported on the casing. Such a fixing method, also known as a shear ring, allows the cover and the seal carrier to be fixed to the casing in a space-saving manner, and simultaneously permits high fixing forces.

Expediently, the fixing rings, which are segmented in the circumferential direction, are screwed on radially and are supported axially on a radially inwards-extending projection of the casing. It is also expedient that the cover is supported axially on a radially inwards-projecting shoulder within the casing, which shoulder serves as an installation endstop. The casing cover is pushed into the casing in the axial direction and is held by means of shear rings segmented in the circumferential direction. Shear rings are known from EP 0 155 581 A2. These are attached by means of a retaining arrangement fixed to the casing.

The two radially inwards-extending projections form, with a section of the casing located axially between these projections, a bracket extending in the circumferential direction which, together with the fixing elements, exerts an axial pre-stress force on the assembly of the seal carrier with the seals and the cover. A simple advantage of this arrangement lies in the possibility that the pressure within the casing is higher than the ambient pressure and thus the cover is pressed against the axial seal of the seal carrier, such that the seal effect is reinforced with increasing internal pressure.

The invention is explained in greater detail below with reference to a specific exemplary embodiment, with reference to drawings.

### BRIEF DESCRIPTION OF THE DRAWINGS

In the drawings:

FIG. 1 is a schematic axial section view of an arrangement according to the invention and

FIG. 2 is a view in schematic representation of detail II from FIG. 1.

### DETAILED DESCRIPTION OF INVENTION

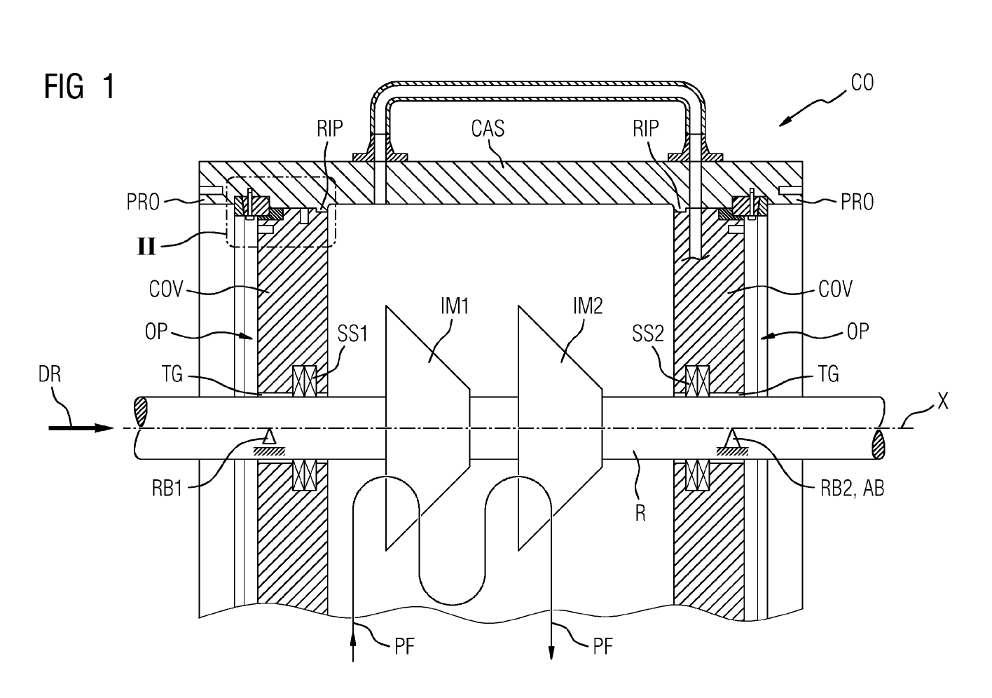

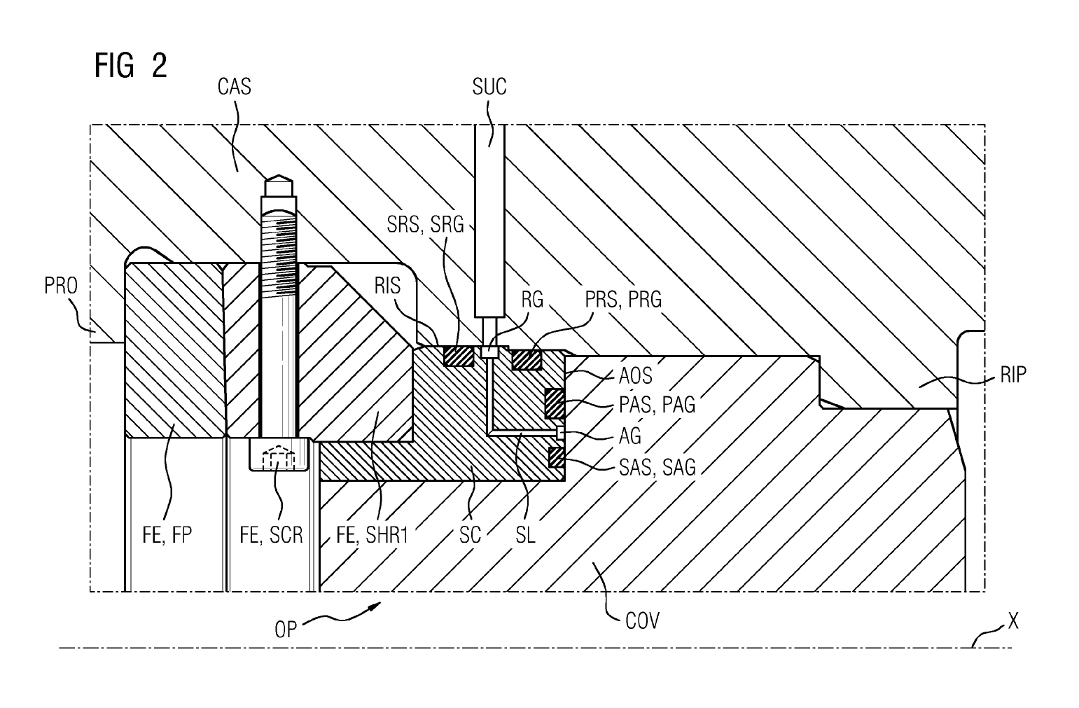

The schematic representation of FIG. 1 shows an axial section through an arrangement according to the invention having a seal, with FIG. 2 showing a detail portion of FIG. 1, labeled II.

An exemplary field of application for the invention is use in turbomachines, in particular turbocompressors or turbo-expanders, as is represented in FIG. 1 with reference to a compressor. The compressor CO shown in FIG. 1 comprises a rotor R which extends along a longitudinal axis X of a casing CAS and is equipped with two impellers, a first impeller IM1 and a second impeller IM2. FIG. 1 indicates that a process fluid PF passes through the compressor by means of the two impellers IM1, IM2 and then leaves the casing CAS. The casing CAS is a casing of what is termed barrel construction, i.e. the casing CAS does not have a parting joint parallel to the longitudinal extent of the casing CAS. In essence, the casing CAS shown consists of a jacket-shaped part and is closed at end-face openings OP by means of two covers COV. The covers COV are surrounded circumferentially by the casing CAS which is cylindrical. The rotor R emerges from both sides of the casing CAS through a through gap TG in each of the covers COV. In order that no leaks occur due to the through gap TG for the rotor R through the cover COV, there are provided, on both sides, shaft seals SS1, SS2 for sealing the resulting gap between the static cover COV and the rotating rotor R. Radial bearings RB1, RB2 are provided for mounting the rotor R on the casing CAS. Axial mounting is brought about by means of an axial bearing AB. The bearings RB1, RB2, AB for mounting the rotor R are particularly advantageously each attached to the cover, such that, also in operation, the cover COV transmits the respective bearing forces to the casing CAS. As a further advantageous refinement of the invention, the exemplary embodiment also shows that the shaft seals SS1, SS2 are each attached to the end-face cover COV located there—as is the case for the bearings RB1 and AB, RB2.

A particularly solid design for the end-face covers COV is necessary due to the possibly high internal pressure in the casing CAS. The radial bearings, and where relevant axial bearings and shaft seals, additionally attached to the cover in the advantageous refinement of the invention require an even more load-bearing design for the end-face cover COV.

FIG. 2 shows the left-hand side arrangement of the seal according to the invention on the cover COV. The cover COV is supported axially on a radially inwards-extending projection RIP of the casing CAS. From the axial cover COV there bears a seal carrier SC with seals attached there to the seal carrier SC. The fixing elements FE, which pre-tension the seal carrier SC and the cover COV against the radially inwards-extending projection RIP, are arranged in further axial sequence in the direction of the casing exterior. In this context, the fixing elements consist of a fitting part FP and a fixing ring, wherein the fitting part and the fixing ring SHR1 each extend segmented in the circumferential direction. The fixing ring SHR1 is directly radially attached to the casing CAS by means of a screw SCR. The fitting part FP, the fixing ring SHR1 and the screw SCR cooperate such that tightening the screw SCR extending in the radial direction increases the axial pre-tension force on the seal carrier SC and on the cover COV. To that end, the fitting part FP and the fixing ring SHR1 can be designed somewhat inclined on their mutual bearing faces such that increasing displacement of the fixing ring SHR1 radially outwards by tightening the screw SCR increases the axial breadth of the entire arrangement of the fixing elements FE. The fitting part FP and the fixing ring SHR1 are axially supported on a radially inwards-extending projection PRO of the casing CAS. In this context, the fixing ring SHR1 could also be directly axially supported on the inwards-extending projection PRO of the casing CAS.

The seal carrier SC has a first radial groove PRG extending in the circumferential direction with a radial depth direction, which receives a first radial seal PRS which seals against a radially inner surface RIS of the casing CAS. Next to the first radial groove PRG is provided a second radial groove SRG with a second radial seal SRS of the seal carrier SC, with the same sealing function. The seal carrier has a first axial groove PAG extending in the circumferential direction with an axial depth direction, in which there is arranged a first axial seal PAS which seals against an axial surface AOS of the cover COV. Next to the first axial groove PAG, the seal carrier SC has a second axial groove SAG with a second axial seal SAS, having essentially the same sealing function. An axial suction groove AG is provided in the seal carrier SC between the first axial seal groove and the second axial seal groove for suctioning any escaping process fluid. A radial suction groove RG is provided between the first radial seal groove and the second radial seal groove, for the same purpose. A suction line SL connects the axial suction groove AG with the radial suction groove RG and a suction SUC. The connection by means of the suction line SL between the axial suction groove AG and the radial suction groove RG runs through the seal carrier SC.

1. An arrangement having a seal, comprising:
a casing (CAS),
a cover (COV),
at least one seal,
wherein the casing (CAS) has a longitudinal axis (X), wherein the cover (COV) is introduced into the casing (CAS) in the axial direction in order to close an end-face opening (OP) of the casing (CAS),
wherein
the arrangement has a seal carrier (SC),
the seal carrier (SC) has a first radial groove (PRG) which extends in the circumferential direction and which has a radial depth direction, in which first radial groove (PRG) there is arranged a first radial seal (PRS) which seals against a radially inner surface (RIS) of the casing (CAS),
the seal carrier (SC) has a first axial groove (PAG) which extends in the circumferential direction and which has an axial depth direction, in which first axial groove (PAG) there is arranged a first axial seal (PAS) which seals against an axial surface (AOS) of the cover (COV),
wherein the cover (COV) is arranged axially further inside the casing (CAS) than the seal carrier (SC), such that the seal carrier (SC) bears with the seals axially against the cover (COV) from the outside.

2. The arrangement as claimed in claim 1,
wherein the casing (CAS) is in the form of a barrel casing without a parting joint extending parallel to the longitudinal axis (X).

3. The arrangement as claimed in claim 1,
wherein the seal carrier (SC) has a second radial groove (SRG) extending in the circumferential direction with a radial depth direction, in which there is arranged a second radial seal (SRS) which seals against the radially inner surface (RIS) of the casing (CAS) and/or
the seal carrier (SC) has a second axial groove (SAG) extending in the circumferential direction with an axial depth direction, in which there is arranged a second axial seal (SAS) which seals against an axial surface (AOS) of the cover (COV).

4. The arrangement as claimed in claim 3,
wherein between the first radial groove (PRG) and the second radial groove (SRG) there is provided on the seal carrier a radial suction groove (RG) extending in the circumferential direction, and/or between the first axial groove (PAG) and the second axial groove (SAG) there is provided an axial suction groove (AG) extending in the circumferential direction, which suction groove(s) is/are connected to at least one suction line (SL).

5. The arrangement as claimed in claim 4,
wherein the suction line (SL) extends from the axial suction groove (AG) through the seal carrier (SC) to the radial suction groove (RG) and continues from the radial suction groove (RG) through the casing (CAS).

6. The arrangement as claimed in claim 1,
wherein the seal carrier (SC) is essentially made of metal.

7. The arrangement as claimed in claim 1, further comprising
fixing elements (FE) for fixing the cover to the casing (CAS), wherein the fixing elements (FE) comprise a fixing ring (SHR1) which extends at least in part in the circumferential direction and is segmented in the circumferential direction, and which bears axially against the seal carrier (SC) and is directly or indirectly fixed and/or supported on the casing (CAS).

8. The arrangement as claimed in claim 7,
wherein the fixing ring (SHR1) is fixed radially on the casing (CAS) and is supported axially on a radially inwards-extending projection (PRO) of the casing (CAS).

9. The arrangement as claimed in claim 8,
wherein the cover is supported axially on a radially inwards-projecting shoulder (RIP) within the casing (CAS), which shoulder (RIP) serves the cover (COV) as a thrust bearing for axial forces from the fixing elements (FE) of the cover (COV).

10. The arrangement as claimed in claim 9,
wherein the arrangement is designed such that the fixing elements (FE) exert axial compressive forces on the seal carrier (SC), which seal carrier (SC) transmits these axial forces to the cover (COV) and the cover (COV) transmits these axial forces to the radially inwards-projecting shoulder (RIP).
